(19) United States
(12) Patent Application Publication
(10) Pub. No.: US 2017/0357829 A1
(43) Pub. Date: Dec. 14, 2017

(54) INTEGRATED CIRCUIT, MOBILE DEVICE HAVING THE SAME, AND HACKING PREVENTING METHOD THEREOF

(71) Applicant: SAMSUNG ELECTRONICS CO., LTD., SUWON-SI (KR)

(72) Inventors: BEOMHEE PARK, SEOUL (KR); KWANGHO KIM, YONGIN-SI (KR); SANGHO KIM, SUWON-SI (KR)

(21) Appl. No.: 15/620,173

(22) Filed: Jun. 12, 2017

(30) Foreign Application Priority Data
Jun. 13, 2016 (KR) 10-2016-0073291
Mar. 10, 2017 (KR) 10-2017-0030769

(51) Int. Cl. G06F 21/70; H03K 3/037; H03K 5/24; G06F 1/28

(52) U.S. Cl. CPC G06F 21/70; G06F 1/28; H03K 3/037; H03K 5/24

(57) ABSTRACT

An integrated circuit includes an internal circuit and an attack detection circuit including at least one sensor configured to sense at least one abnormal condition of the internal circuit. The at least one abnormal condition is a parameter of the internal circuit that is outside of a predetermined range. The attack detection circuit is configured to sense an external attack on the internal circuit based on the at least one abnormal condition. The attack detection circuit further includes a security built-in-self-test (BIST) circuit configured to sense a physical attack on the attack detection circuit.

### CROSS-REFERENCE TO RELATED APPLICATIONS

This application claims priority under 35 U.S.C. §119 to Korean Patent Application Nos. 10-2016-0073291, filed on Jun. 13, 2016, and 10-2017-0030769, filed on Mar. 10, 2017, in the Korean Intellectual Property Office, the disclosures of which are incorporated by reference herein in their entireties.

### TECHNICAL FIELD

Exemplary embodiments of the inventive concept relate to a semiconductor circuit, and more specifically, to an integrated circuit, a mobile device including the same, and a hacking preventing method thereof.

### DISCUSSION OF RELATED ART

With developments in system hacking techniques, hackers may attempt to extract significant information (e.g., private information, financial information, and technical know-how) from systems through various methods. A system may include an attack detection circuit that helps prevent hacking by detecting abnormal conditions in associated circuitry. A hacker may attempt to make the attack detection circuit weak and ineffective by physically damaging a chip therein or through a laser fault attack, thus circumventing the security provided by the attack detection circuit.

### SUMMARY

According to an exemplary embodiment of the inventive concept, an integrated circuit may include an internal circuit and an attack detection circuit including at least one sensor configured to sense at least one abnormal condition of the internal circuit. The at least one abnormal condition is a parameter of the internal circuit that is outside of a predetermined range. The attack detection circuit is configured to sense an external attack on the internal circuit based on the at least one abnormal condition. The attack detection circuit further includes a security built-in-self-test (BIST) circuit configured to sense a physical attack on the attack detection circuit.

According to an exemplary embodiment of the inventive concept, an integrated circuit may include an internal circuit and an attack detection circuit configured to sense an external attack on the internal circuit. The attack detection circuit may include a plurality of sensors configured to sense different abnormal conditions, a plurality of built-in-self-test (BIST) units corresponding to the plurality of sensors, a comparator, and a detector. Each of the plurality of BIST units is configured to output one of a voltage from a corresponding sensor, a ground voltage, and a power supply voltage as an output value. The comparator compares each of the output values of the plurality of BIST units with a reference voltage and outputs at least one result value. The detector generates an attack notification signal in response to the at least one result value of the comparator.

According to an exemplary embodiment of the inventive concept, a mobile device may include an application processor, a memory that stores data used for an operation of the application processor, and a security chip that performs a security operation of the application processor. The security chip may include an attack detection circuit including a security built-in-self-test (BIST) circuit that senses a physical attack or a laser fault attack on the attack detection circuit.

According to an exemplary embodiment of the inventive concept, an operating method of an attack detection circuit configured to sense an external attack on an internal circuit may include receiving a built-in-self-test (BIST) enable signal, performing a security BIST operation in response to the security BIST enable signal, determining a normal state or an attack state of the attack detection circuit using a result of the security BIST operation, sending an attack notification signal to the internal circuit when the attack detection circuit is in the attack state, and shutting down the internal circuit, resetting the internal circuit, or deleting data used in the internal circuit, in response to the attack notification signal. The normal state of the attack detection circuit is a state in which a physical attack on the attack detection circuit has not occurred, and the attack state of the attack detection circuit is a state in which the physical attack on the attack detection circuit has occurred.

### BRIEF DESCRIPTION OF THE DRAWINGS

The above and other objects and features of the inventive concept will become apparent by describing in detail exemplary embodiments thereof with reference to the accompanying drawings.

FIG. 1 is a diagram illustrating an integrated circuit, according to an exemplary embodiment of the inventive concept.

FIG. 2 is a diagram illustrating an attack detection circuit of FIG. 1 according to an exemplary embodiment of the inventive concept.

FIG. 3 is a diagram illustrating an abnormal condition sensing circuit of FIG. 2 according to an exemplary embodiment of the inventive concept.

FIG. 4 is a diagram illustrating an attack detection circuit according to an exemplary embodiment of the inventive concept.

FIG. 5 is a diagram illustrating an attack detection circuit according to an exemplary embodiment of the inventive concept.

FIG. 6 is a flowchart illustrating a process in which the integrated circuit of FIG. 1 performs a hacking preventing operation according to an exemplary embodiment of the inventive concept.

FIGS. 7A, 7B, and 7C are diagrams illustrating a normal mode and a security BIST mode of an attack detection circuit according to exemplary embodiments of the inventive concept.

FIG. 8 is a diagram illustrating a process of determining a normal state/attack state of an attack detection circuit according to an exemplary embodiment of the inventive concept.

FIG. 9 is a diagram illustrating a comparator of FIG. 2 according to an exemplary embodiment of the inventive concept.

FIG. 10 is a diagram illustrating the integrated circuit according to an exemplary embodiment of the inventive concept.

FIG. 11 is a diagram illustrating an attack detection circuit of FIG. 10 according to an exemplary embodiment of the inventive concept.

FIG. 12 is a diagram illustrating a laser detector according to an exemplary embodiment of the inventive concept.

FIGS. 13A, 13B, 13C, and 13D are diagrams illustrating a laser detector in more detail according to exemplary embodiments of the inventive concept.

FIG. 14 is a diagram illustrating an attack detection circuit including a reference voltage generating circuit according to an exemplary embodiment of the inventive concept.

FIG. 15 is a flowchart illustrating a process in which the integrated circuit of FIG. 10 performs a hacking preventing operation according to an exemplary embodiment of the inventive concept.

FIG. 16 is a diagram illustrating an integrated circuit according to an exemplary embodiment of the inventive concept.

FIG. 17 is a diagram illustrating a security system according to an exemplary embodiment of the inventive concept.

FIG. 18 is a diagram illustrating a security system according to an exemplary embodiment of the inventive concept.

FIG. 19 is a diagram illustrating a security chip configured to be inserted into a mobile device according to an exemplary embodiment of the inventive concept.

FIG. 20 is a diagram illustrating a mobile device according to an exemplary embodiment of the inventive concept.

FIG. 21 is a diagram illustrating an electronic device according to an exemplary embodiment of the inventive concept.

### DETAILED DESCRIPTION OF THE EMBODIMENTS

Exemplary embodiments of the inventive concept will be described more fully hereinafter with reference to the accompanying drawings. Like reference numerals may refer to like elements throughout this application.

Exemplary embodiments of the inventive concept provide an integrated circuit that protects an attack detection circuit from physical damage or a laser fault attack, a mobile device including the same, and an operating method thereof.

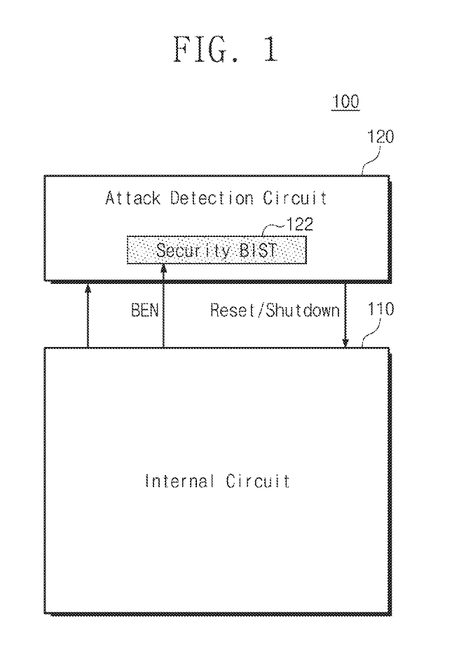

FIG. 1 is a diagram illustrating an integrated circuit according to an exemplary embodiment of the inventive concept. Referring to FIG. 1, an integrated circuit 100 may include an internal circuit 110 and an attack detection circuit 120. Here, the attack detection circuit 120 may be a circuit for protecting the internal circuit 110 from at least one attack.

The integrated circuit 100 may be included in, for example, security products such as a smart card, an embedded security element (eSE), a universal subscriber identity module (USIM) card, a financial security and identification (FSID) card, a mobile trusted platform module (TPM), a brand protection product, or an IoT (internet of things) wearable device product.

The internal circuit 110 may be implemented to provide at least one security function to the above-described security products. For example, the security function may be a function associated with confidentiality of data, integrity, availability, or access control and authority of a user. According to an exemplary embodiment of the inventive concept, the internal circuit 110 may be implemented with one chip. For example, the internal circuit 110 may be implemented with a system-on-chip (SoC).

To protect the internal circuit 110 from an external attack, the attack detection circuit 120 may be implemented to detect whether the internal circuit 110 operates abnormally, e.g., due to hacking. For example, the attack detection circuit 120 may be implemented to detect an attack on the internal circuit 110 using a glitch, a voltage, a temperature, a frequency, etc.

The attack detection circuit 120 may include a security built-in-self-test (BIST) circuit 122. The security BIST circuit 122 may be implemented to detect whether all or a part of a configuration of the attack detection circuit 120 is physically damaged or subjected to a laser fault attack.

Additionally, the security BIST circuit 122 may be implemented to be activated in response to a BIST enable signal BEN. According to an exemplary embodiment of the inventive concept, the BIST enable signal BEN may be transmitted from the internal circuit 110 periodically or randomly. For example, after the integrated circuit 100 is powered on and a reference time elapses therefrom, the BIST enable signal BEN may be generated periodically. According to an exemplary embodiment of the inventive concept, the BIST enable signal BEN may be generated according to an internal policy of the integrated circuit 100. According to an exemplary embodiment of the inventive concept, the BIST enable signal BEN may be generated according to a predetermined policy in the attack detection circuit 120 itself.

The attack detection circuit 120 may be implemented to generate an attack notification signal when detecting an external attack on the internal circuit 110 or the attack detection circuit 120. The internal circuit 110 may be reset or shut down in response to the attack notification signal. Additionally, the internal circuit 110 may delete significant data, which should not be leaked to the outside, in response to the attack notification signal.

According to an exemplary embodiment of the inventive concept, the integrated circuit 100 may detect an external attack on the attack detection circuit 120 as well as the internal circuit 110, and may perform a protection function based on the detection result, thus increasing security thereof.

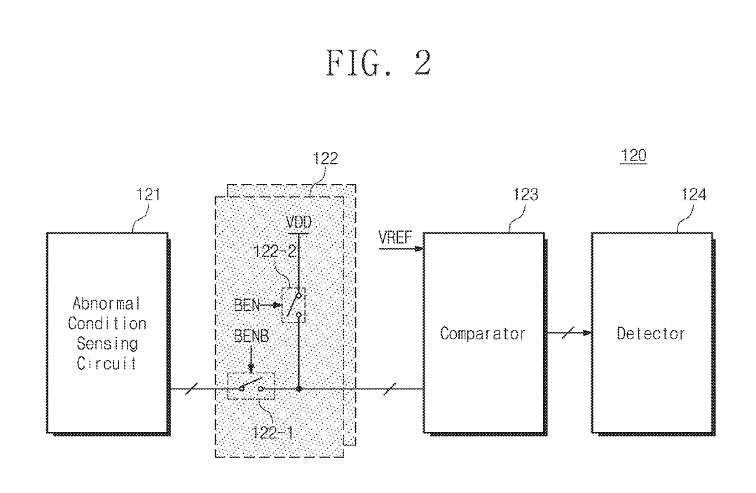

FIG. 2 is a diagram illustrating an attack detection circuit of FIG. 1 according to an exemplary embodiment of the inventive concept. Referring to FIG. 2, the attack detection circuit 120 may include an abnormal condition sensing circuit 121, the security BIST circuit 122, a comparator 123, and a detector 124.

The abnormal condition sensing circuit 121 may be implemented to sense various abnormal conditions of the internal circuit 110. For example, the abnormal conditions may include a voltage, a current, a frequency, a temperature, etc. that are out of a normal range. The abnormal condition sensing circuit 121 may include a plurality of abnormal condition detectors that sense the abnormal conditions. According to an exemplary embodiment of the inventive concept, sensing results of the abnormal condition sensing circuit 121 may be provided to the security BIST circuit 122.

The security BIST circuit 122 may include a floating switch 122-1 and a pull-up switch 122-2.

According to an exemplary embodiment of the inventive concept, the floating switch 122-1 may be implemented to float an output terminal of the security BIST circuit 122. For example, when the floating switch 122-1 is turned off in response to an inverted BIST enable signal BENB, an output terminal of the abnormal condition sensing circuit 121 may be isolated from the output terminal of the security BIST circuit 122. Additionally, when the floating switch 122-1 is turned on in response to the inverted BIST enable signal BENB, the output terminal of the abnormal condition sensing circuit 121 may be connected to the output terminal of the security BIST circuit 122.

According to an exemplary embodiment of the inventive concept, the pull-up switch 122-2 may be turned on in response to the BIST enable signal BEN to electrically connect a power terminal to the output terminal of the security BIST circuit 122. The power terminal is provided with a power supply voltage VDD. Additionally, the pull-up switch 122-2 may be turned off in response to the BIST enable signal BEN to electrically disconnect the power terminal and the output terminal of the security BIST circuit 122.

The security BIST circuit 122 may detect whether the attack detection circuit 120 operates normally, in response to the BIST enable signal BEN. For example, when the pull-up switch 122-2 is turned on in response to the BIST enable signal BEN, the comparator 123 may compare the power supply voltage VDD, compulsorily supplied to the output terminal of the security BIST circuit 122, with a reference voltage VREF. A comparison result value of the comparator 123 may include information indicating whether the attack detection circuit 120 is operating normally.

For descriptive convenience, the security BIST circuit 122 is illustrated in FIG. 2 as being implemented with one BIST unit corresponding to one abnormal condition sensor. It may be understood that the security BIST circuit 122 according to exemplary embodiments of the inventive concept may include a plurality of BIST units corresponding to a plurality of abnormal condition sensors.

The detector 124 may be implemented to receive at least one output value of the comparator 123 and to determine whether the attack detection circuit 120 is attacked from the outside. For example, if a current output value of the comparator 123 changes compared with a previous output value of the comparator 123 in a previous state, it may be determined that an external attack on the attack detection circuit 120 has not occurred. Here, the previous state is a state in which the floating switch 122-1 is turned on and the pull-up switch 122-2 is turned off. According to an exemplary embodiment of the inventive concept, the previous state may indicate an operation state or an operation mode in which the integrated circuit 100 performs a normal operation.

In contrast, if the current output value of the comparator 123 does not change compared with (e.g., is the same as) the previous output value in the previous state, it may be determined that an external attack on the attack detection circuit 120 has occurred.

In FIG. 2, the attack detection circuit 120 is illustrated as including the comparator 123 and the detector 124. However, the inventive concept is not limited thereto. For example, in an attack detection circuit according to an exemplary embodiment of the inventive concept, a comparator and a detector may be implemented with one component.

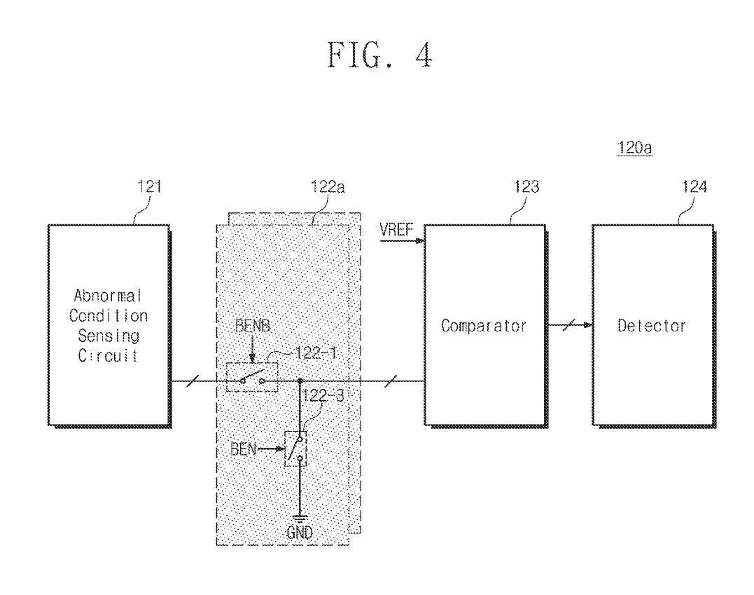

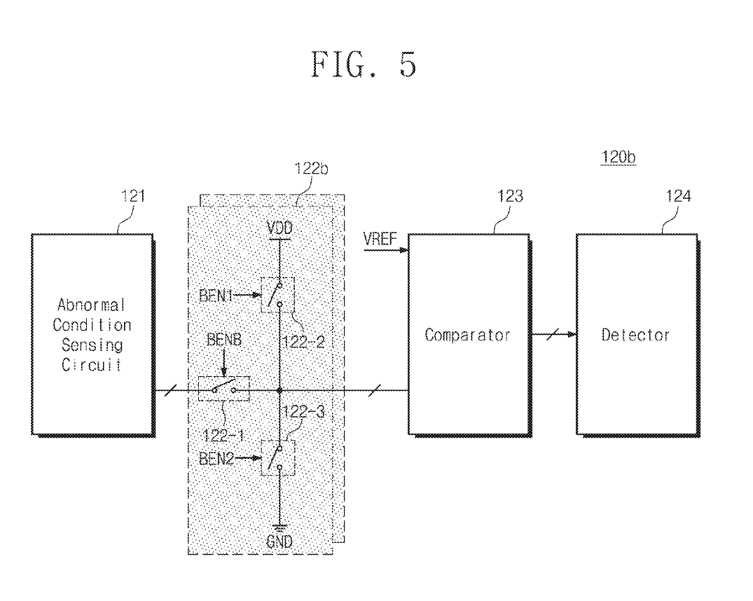

In FIG. 2, the security BIST circuit 122 is implemented with a pull-up switch structure. However, the inventive concept is not limited thereto. For example, the security BIST circuit 122 may be implemented with a pull-down switch structure or a pull-up/pull-down switch structure, as will be described below with reference to FIGS. 4 and 5.

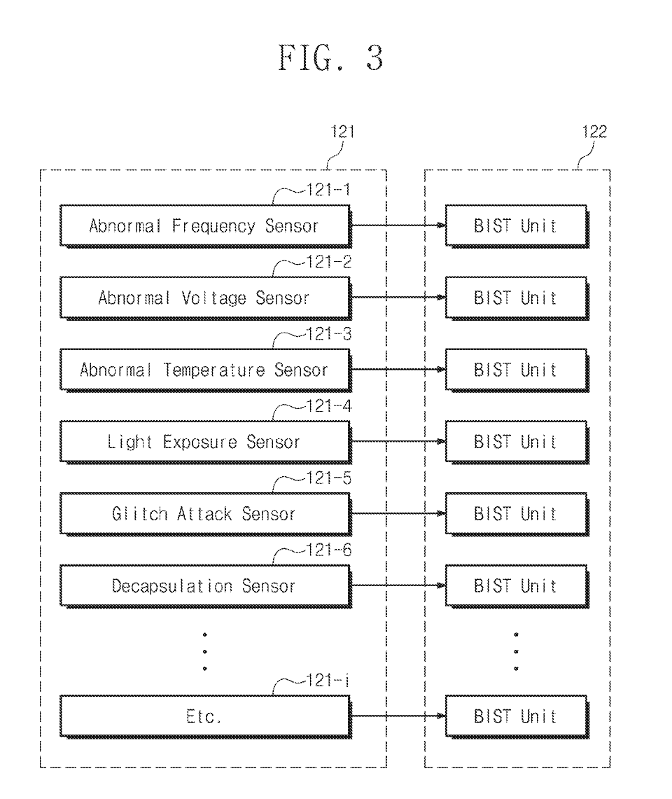

FIG. 3 is a diagram illustrating an abnormal condition sensing circuit of FIG. 2 according to an exemplary embodiment of the inventive concept. Referring to FIG. 3, the abnormal condition sensing circuit 121 may include an abnormal frequency sensor 121-1, an abnormal voltage sensor 121-2, an abnormal temperature sensor 121-3, a light exposure sensor 121-4, a glitch attack sensor 121-5, a decapsulation sensor 121-6, and any other sensors 121-i.

The abnormal frequency sensor 121-1 may be implemented to detect a main clock frequency and to generate a sensing signal when the detected main clock frequency is out of a specified range. The abnormal voltage sensor 121-2 may be implemented to detect a level of an externally supplied voltage and to generate a sensing signal when the detected level of the externally supplied voltage is out of a rated range. The abnormal temperature sensor 121-3 may be implemented to detect a peripheral temperature of the integrated circuit 100 and to generate a sensing signal when the detected peripheral temperature is higher than or lower than a reference range. The light exposure sensor 121-4 may be implemented to generate a sensing signal when a silicon oxide layer used as a protection layer of the integrated circuit 100 is removed and the integrated circuit 100 is exposed to external light. The glitch attack sensor 121-5 may be implemented to detect fluctuations of a power supply voltage and to generate a sensing signal when the power supply voltage changes suddenly. The decapsulation sensor 121-6 may be implemented to generate a detection signal when the integrated circuit 100 is decapsulated.

As illustrated in FIG. 3, the security BIST circuit 122 may include a plurality of BIST units corresponding to the sensors 121-1 to 121-i, respectively, of the abnormal condition sensing circuit 121.

FIG. 4 is a diagram illustrating an attack detection circuit according to an exemplary embodiment of the inventive concept. Referring to FIG. 4, an attack detection circuit 120a may be implemented to be substantially the same as the attack detection circuit 120 of FIG. 2 except for a security BIST circuit 122a having a pull-down switch 122-3.

The security BIST circuit 122a may include the floating switch 122-1 floating at least one output value (e.g., a sensing signal) of the abnormal condition sensing circuit 121 and the pull-down switch 122-3 connected to a ground terminal. According to an exemplary embodiment of the inventive concept, the floating switch 122-1 in FIG. 4 may perform a function similar to the floating switch 122-1 in FIG. 2. According to an exemplary embodiment of the inventive concept, a ground voltage GND may be provided to the ground terminal.

According to an exemplary embodiment of the inventive concept, the pull-down switch 122-3 may be turned on in response to the BIST enable signal BEN, and the floating switch 122-1 may be turned off in response to the inverted BIST enable signal BENB. According to an exemplary embodiment of the inventive concept, the pull-down switch 122-3 may be turned off in response to the BIST enable signal BEN, and the floating switch 122-1 may be turned on in response to the inverted BIST enable signal BENB.

The security BIST circuit 122a may detect whether the attack detection circuit 120a is operating normally, in response to the BIST enable signal BEN. For example, when the pull-down switch 122-3 of the security BIST circuit 122a is turned on, the comparator 123 may compare the ground voltage GND, compulsorily supplied to the output terminal of the security BIST circuit 122a, with the reference voltage VREF. The comparison result value may indicate whether an external attack is performed on the attack detection circuit 120a.

The security BIST circuit 122 of FIG. 2 includes a pull-up circuit structure, and the security BIST circuit 122a of FIG. 4 includes a pull-down circuit structure. However, the inventive concept is not limited thereto. For example, a security BIST circuit according to an exemplary embodiment of the inventive concept may be implemented with a structure including both a pull-up circuit and a pull-down circuit. In this case, the pull-up circuit and the pull-down circuit may be selectively activated to be optimized for each sensor (e.g., 121-1 to 121-i of FIG. 3) of the abnormal condition sensing circuit 121. For example, a part (e.g., the abnormal frequency sensor 121-1) of the sensors may be connected to a security BIST circuit with a pull-up structure, and another part (e.g., the glitch attack sensor 121-5) of the sensors may be connected to a security BIST circuit with a pull-down structure.

FIG. 5 is a diagram illustrating an attack detection circuit according to an exemplary embodiment of the inventive concept. Referring to FIG. 5, an attack detection circuit 120b may be implemented to be substantially the same as the attack detection circuit 120 of FIG. 2, except for a security BIST circuit 122b having both the pull-up switch 122-2 and the pull-down switch 122-3.

The security BIST circuit 122b may include the floating switch 122-1 that is turned on in response to the inverted BIST enable signal BENB, the pull-up switch 122-2 that is turned on in response to a first BIST enable signal BEN1, and the pull-down switch 122-3 that is turned on in response to a second BIST enable signal BEN2. According to an exemplary embodiment of the inventive concept, one of the first BIST enable signal BEN1 and the second BIST enable signal BEN2 may be the BIST enable signal BEN, and the other thereof may be a signal having the ground voltage GND. However, the inventive concept is not limited thereto.

According to an exemplary embodiment of the inventive concept, both the pull-up switch 122-2 and the pull-down switch 122-3 may be turned off when the floating switch 122-1 is turned on in response to the inverted BIST enable signal BENB. According to an exemplary embodiment of the inventive concept, one of the pull-up switch 122-2 and the pull-down switch 122-3 may be turned on when the floating switch 122-1 is turned off in response to the inverted BIST enable signal BENB.

One security BIST circuit 122b is illustrated in FIG. 5 for descriptive convenience. It may be understood that the security BIST circuit 122b of FIG. 5 is provided to correspond to various attack sensors 121-1 to 121-i of FIG. 3.

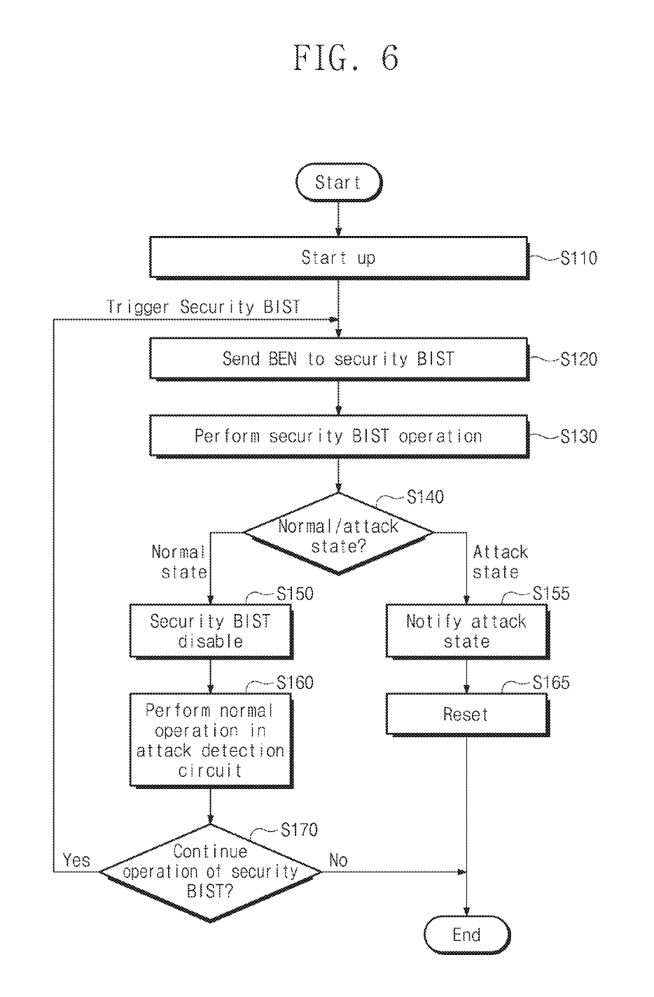

FIG. 6 is a flowchart illustrating a process in which the integrated circuit of FIG. 1 performs a hacking preventing operation according to an exemplary embodiment of the inventive concept. The hacking preventing operation of the integrated circuit 100 will be described with reference to FIGS. 1 to 6.

The integrated circuit 100 may start to perform an operation (S110). For example, the integrated circuit 100 may start to perform an operation by booting-up a system including the integrated circuit 100, by providing the integrated circuit 100 with power, or under the control of an external device connected to the integrated circuit 100. According to an exemplary embodiment of the inventive concept, when the integrated circuit 100 starts to perform an operation, the integrated circuit 100 may enter a security BIST mode to perform a security BIST operation. The security BIST operation will be described with reference to further operations below.

For example, the internal circuit 110 of FIG. 1 of the integrated circuit 100 may send the BIST enable signal BEN to the security BIST circuit 122 periodically or randomly to enter the security BIST mode (S120). The security BIST circuit 122 of the attack detection circuit 120 of FIG. 1 may be activated in response to the BIST enable signal BEN.

The security BIST circuit 122 may block output values of the abnormal condition sensing circuit 121 in response to the BIST enable signal BEN. The security BIST circuit 122 may perform the security BIST operation for compulsorily pulling an output terminal (e.g., an attack sensing terminal) of the security BIST circuit 122 up to the power supply voltage VDD or down to the ground voltage GND (S130).

It may be determined whether the attack detection circuit 120 is attacked based on an execution result of the security BIST operation (S140). If the result of the security BIST operation, e.g., a result of comparing a previous output value and a current output value, indicates that a level changes, it may be determined that an external attack on the attack detection circuit 120 has not occurred. In other words, the attack detection circuit 120 is in a normal state. In contrast, if the result of the security BIST operation indicates that the previous output value is maintained (e.g., there is no change in level), it may be determined that an external attack on the attack detection circuit 120 has occurred. In other words, the attack detection circuit 120 is in an attack state.

If the attack detection circuit 120 is in the normal state, the security BIST circuit 122 may be deactivated (S150). In this case, the abnormal condition sensing circuit 121 of the attack detection circuit 120 may perform a normal operation (S160). It is then determined whether an operation of the attack detection circuit 120 is to be continued (S170). If so, the security BIST circuit 122 may be activated periodically or according to a policy (e.g., returning back to S120). Otherwise, an operation of the attack detection circuit 120 terminates.

In contrast, if the attack detection circuit 120 is in the attack state, the attack detection circuit 120 may notify the attack state to the internal circuit 110 (S155). The internal circuit 110 may be reset or shut down in response to a notification signal of the attack state or may delete significant information (e.g., private information and financial information) that should not be hacked (S165). According to an exemplary embodiment of the inventive concept, the significant information to be deleted may be determined in advance.

Accordingly, the integrated circuit 100 according to an exemplary embodiment of the inventive concept may monitor an attack state of the attack detection circuit 120 as well as the internal circuit 110, thus providing a safer and more secure hacking security policy.

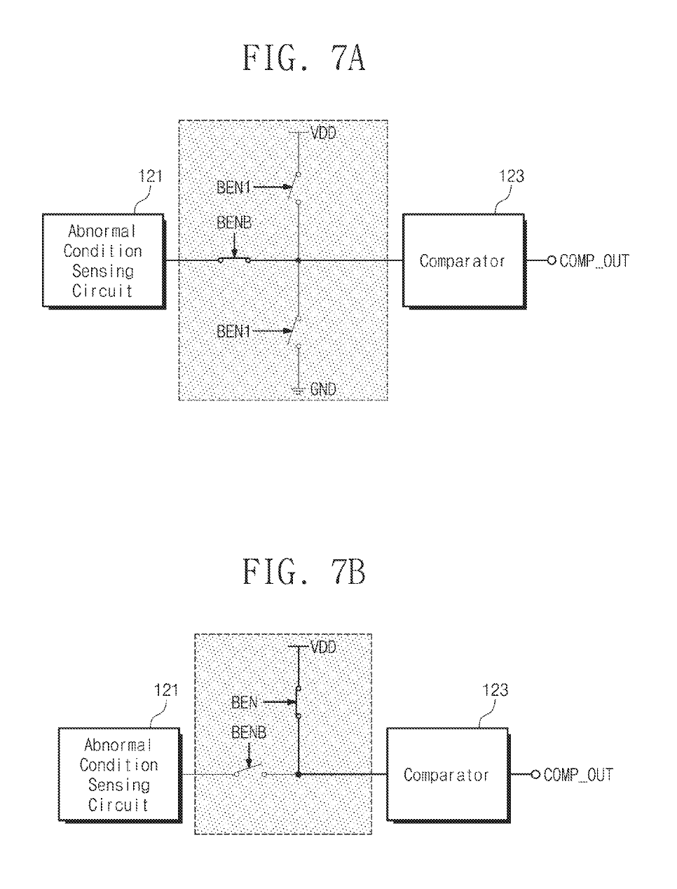

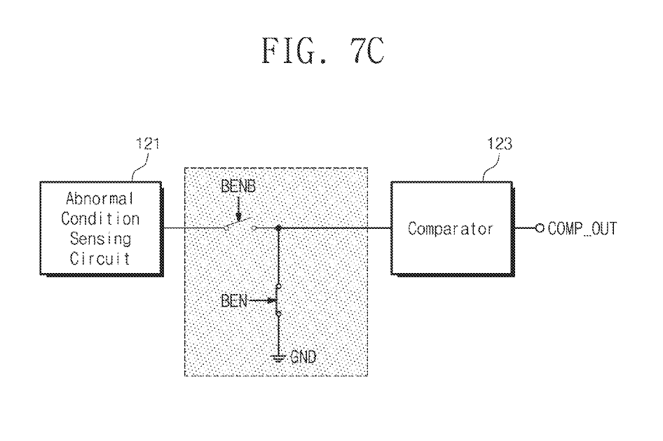

FIGS. 7A, 7B, and 7C are diagrams illustrating a normal mode and a security BIST mode of an attack detection circuit according to exemplary embodiments of the inventive concept. FIG. 7A is an example diagram illustrating a normal mode of an attack detection circuit (e.g., the attack detection circuit 120B of FIG. 5). FIGS. 7B and 7C are example diagrams illustrating a security BIST mode of an attack detection circuit.

In FIGS. 7A, 7B, and 7C, an attack detection circuit is connected to the abnormal condition sensing circuit 121 and the comparator 123. The comparator 123 outputs an output value COMP_OUT.

Referring to FIG. 7A, a floating switch of a security BIST circuit is in a turn-on state, and pull-up/pull-down switches are in a turn-off state. FIG. 7B is a diagram illustrating the security BIST mode implemented with a pull-up switch in an attack detection circuit. Referring to FIG. 7B, the pull-up switch of the security BIST circuit is in a turn-on state, and the floating switch is in a turn-off state. FIG. 7C is a diagram illustrating the security BIST mode implemented with a pull-down switch in the attack detection circuit. Referring to FIG. 7C, the pull-down switch of the security BIST circuit is in a turn-on state, and the floating switch is in a turn-off state.

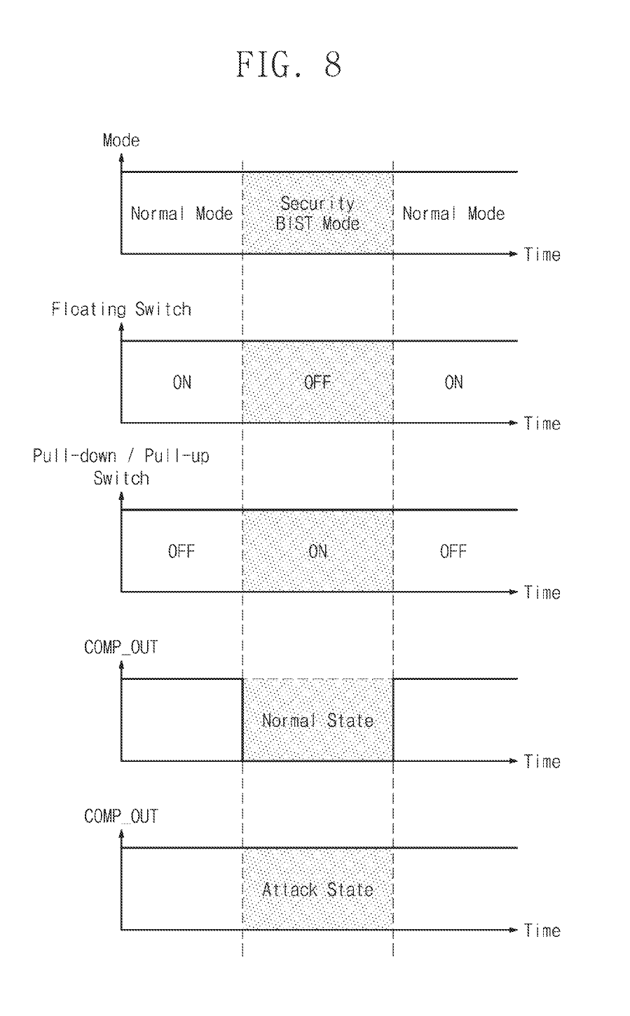

FIG. 8 is a diagram illustrating a process of determining a normal state/attack state of an attack detection circuit according to an exemplary embodiment of the inventive concept. A process of determining a normal/attack state of an attack detection circuit (e.g., the attack detection circuit 120B of FIG. 5) will be described with reference to FIGS. 1 to 8.

The attack detection circuit operates in a normal mode or a security BIST mode. Since a floating switch of a security BIST circuit is turned on in the normal mode, output values of an abnormal condition sensing circuit may be normally sent to the comparator 123 (refer to FIG. 2). In contrast, in the security BIST mode, since the floating switch of the security BIST circuit is turned off and the pull-up switch or pull-down switch thereof is turned on, the power supply voltage VDD or the ground voltage GND may be compulsorily supplied to the comparator 123.

According to an exemplary embodiment of the inventive concept, in the normal state of the attack detection circuit, the output value COMP_OUT of the comparator 123 may change. In contrast, in the attack state of the attack detection circuit, the output value COMP_OUT of the comparator 123 may be uniform without any change. According to an exemplary embodiment of the inventive concept, the change of the output value COMP_OUT may indicate a change or a difference between output values in each of the normal mode and the security BIST mode.

For example, if the attack detection circuit is in the normal state (e.g., there is no attack from attackers), an output of the security BIST circuit will change by the power supply voltage VDD or the ground voltage GND that is compulsorily supplied. In other words, the attack detection circuit can detect the power supply voltage VDD or the ground voltage GND that is compulsorily supplied. Thus, when the output value COMP_OUT of the comparator 123 changes, the attack detection circuit is operating normally and is in the normal state.

In contrast, if the attack detection circuit is in the attack state (e.g., there is an attack from attackers), an output of the security BIST circuit may not change by the power supply voltage VDD or the ground voltage GND that is compulsorily supplied. Thus, the attack detection circuit cannot detect a change by the power supply voltage VDD or the ground voltage GND that is compulsorily supplied. In other words, when the output value COMP_OUT of the comparator 123 does not change, the attack detection circuit abnormally operates and is in the attack state.

FIG. 8 is an example graph for ease of description. In other words, signals or change of signals illustrated in FIG. 8 are only examples, and the inventive concept is not limited thereto.

According to an exemplary embodiment of the inventive concept, if an external attack is detected during a normal operation mode of the attack detection circuit, the output value COMP_OUT of the comparator 123 may change.

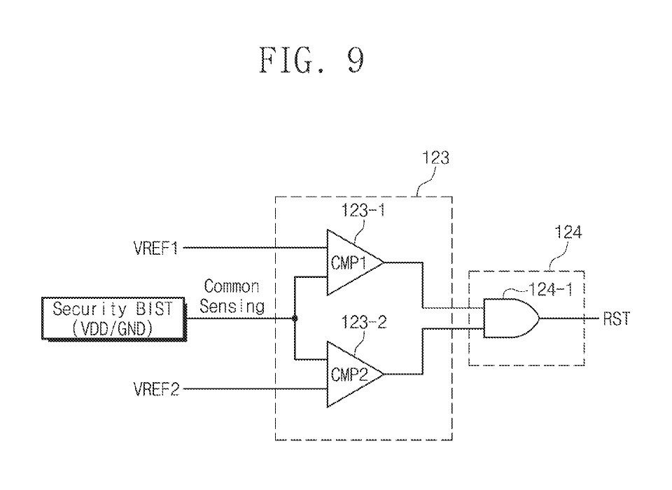

FIG. 9 is a diagram illustrating a comparator of FIG. 2 according to an exemplary embodiment of the inventive concept. For descriptive convenience, two comparison units (CMP1 and CMP2) 123-1 and 123-2 are illustrated in FIG. 9. However, the number of comparison units is not limited thereto. The comparison units 123-1 and 123-2 may be implemented to compare an output value of the security BIST circuit 122 of FIG. 2 with corresponding first and second reference voltages VREF1 and VREF2, respectively. In the security BIST mode, each of the comparison units 123-1 and 123-2 may receive the corresponding reference voltage and either the power supply voltage VDD (in a pull-up switch structure) or the ground voltage GND (in a pull-down switch structure).

According to an exemplary embodiment of the inventive concept, the first reference voltage VREF1 and the second reference voltage VREF2 may have different voltage levels. According to an exemplary embodiment of the inventive concept, the first reference voltage VREF1 and the second reference voltage VREF2 may have substantially the same voltage level.

If the attack detection circuit is attacked, output values of the comparison units 123-1 and 123-2 may not be changed by a compulsorily received voltage VDD or GND. The detector 124 may include a logic circuit 124-1 that performs a logical operation on output values of the comparison units 123-1 and 123-2. For example, the logic circuit 124-1 may be implemented to perform an AND operation. When logical levels of the output values of the comparison units 123-1 and 123-2 are substantially the same as each other, the detector 124 may generate an attack notification signal RST providing notification of an external attack. It should be understood that a configuration of the comparator 124 is not limited to a logical AND operation as illustrated, but can be implemented using equivalent logic circuits.

According to exemplary embodiments of the inventive concept, a laser detector that detects a laser fault attack may be included in each of the internal configurations of the attack detection circuits described above with reference to FIGS. 1 to 9. The laser detector may be used to monitor a laser fault attack on an internal configuration circuit of the attack detection circuit.

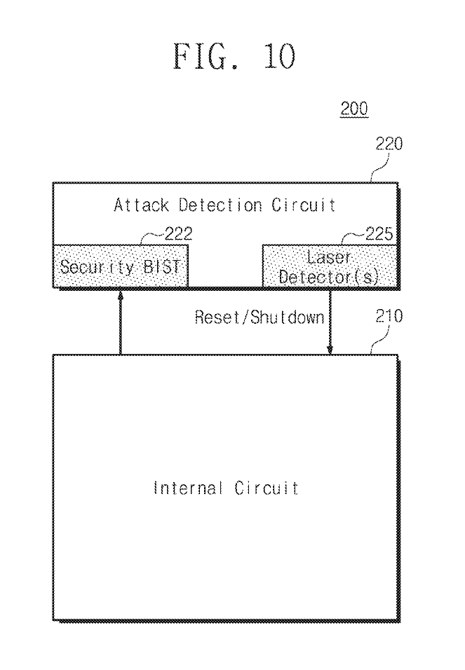

FIG. 10 is a diagram illustrating an integrated circuit according to an exemplary embodiment of the inventive concept. Referring to FIG. 10, an integrated circuit 200 may include an internal circuit 210 and an attack detection circuit 220. The attack detection circuit 220 may include a security BIST circuit 222 and at least one laser detector 225. The security BIST circuit 222 may be implemented to detect whether the attack detection circuit 220 operates normally. The laser detector 225 may be implemented to detect a laser fault attack on the attack detection circuit 220. The internal circuit 210 may be reset or shut down immediately when the laser fault attack on the attack detection circuit 220 is detected.

FIG. 11 is a diagram illustrating an attack detection circuit of FIG. 10 according to an exemplary embodiment of the inventive concept. Referring to FIG. 11, the attack detection circuit 220 may be implemented to be substantially the same as the attack detection circuit 120b of FIG. 5, except that laser detectors 225-1, 225-2, 225-3, and 225-4 are included in internal configurations of an abnormal condition sensing circuit 221, the security BIST circuit 222, a comparator 223, and a detector 224, respectively. Here, each of the laser detectors 225-1, 225-2, 225-3, and 225-4 may be implemented to sense the laser fault attack and to reset or shut down the internal circuit 210 based on a sensing result.

Each of the laser detectors 225-1, 225-2, 225-3, and 225-4 may be implemented with a latch circuit.

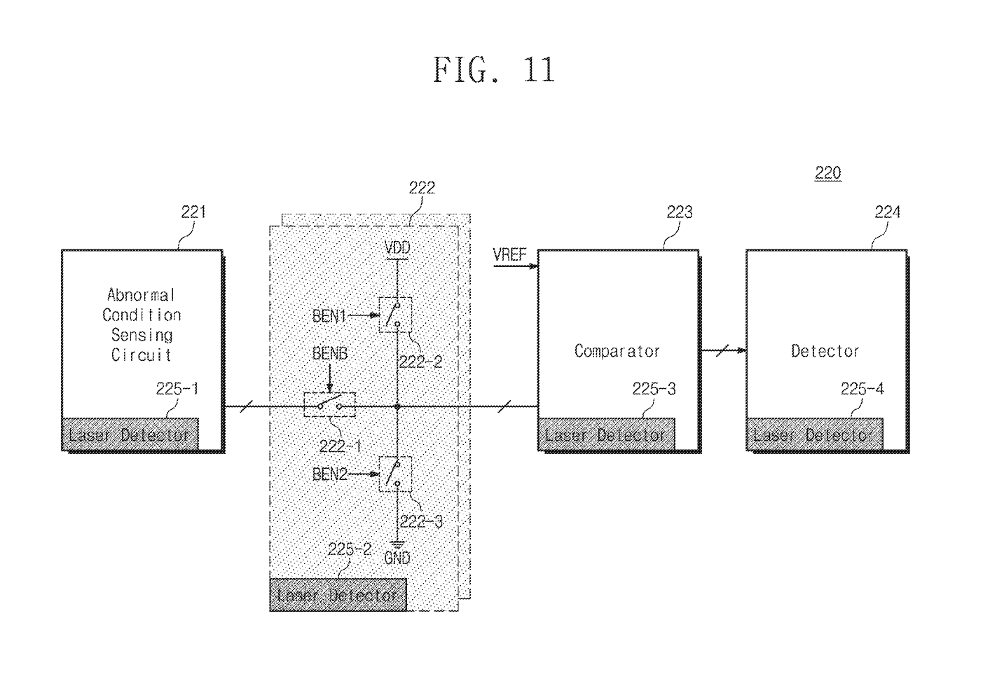

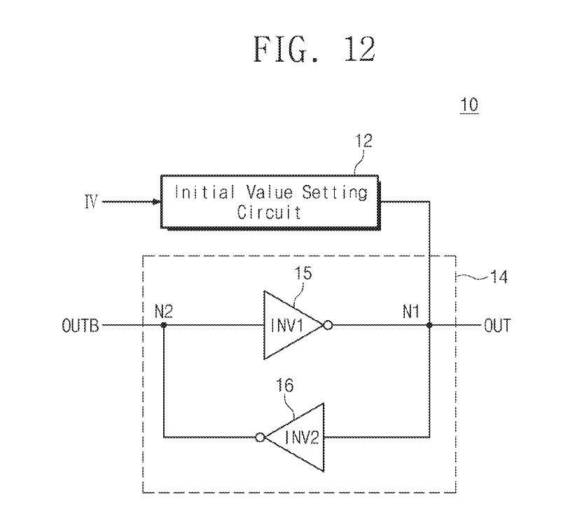

FIG. 12 is a diagram illustrating a laser detector according to an exemplary embodiment of the inventive concept. Referring to FIG. 12, a laser detector 10 may include an initial value setting circuit 12 and a latch circuit 14. The initial value setting circuit 12 may be implemented to set an initial value of a first node N1 in response to an initial value signal IV. The latch circuit 14 may be implemented to latch the initial value.

According to an exemplary embodiment of the inventive concept, the initial value signal IV may be generated in an internal circuit. The latch circuit 14 may include inverters (INV1 and INV2) 15 and 16 that are connected back-to-back between the first node N1 and a second node N2. In the case of a laser fault attack, the initial value of the first node N1 may be changed due to a leakage current of the latch circuit 14. The laser detector 10 may generate an output signal OUT at the first node N1 indicating whether the initial value is changed. Additionally, the laser detector 10 may generate an inverted output signal OUTB at the second node N2.

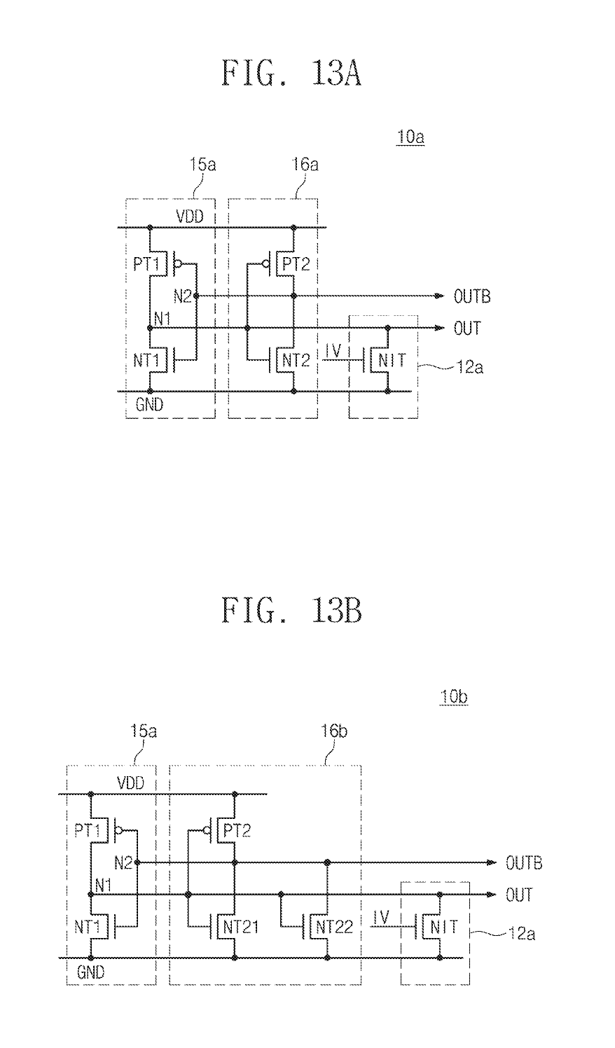

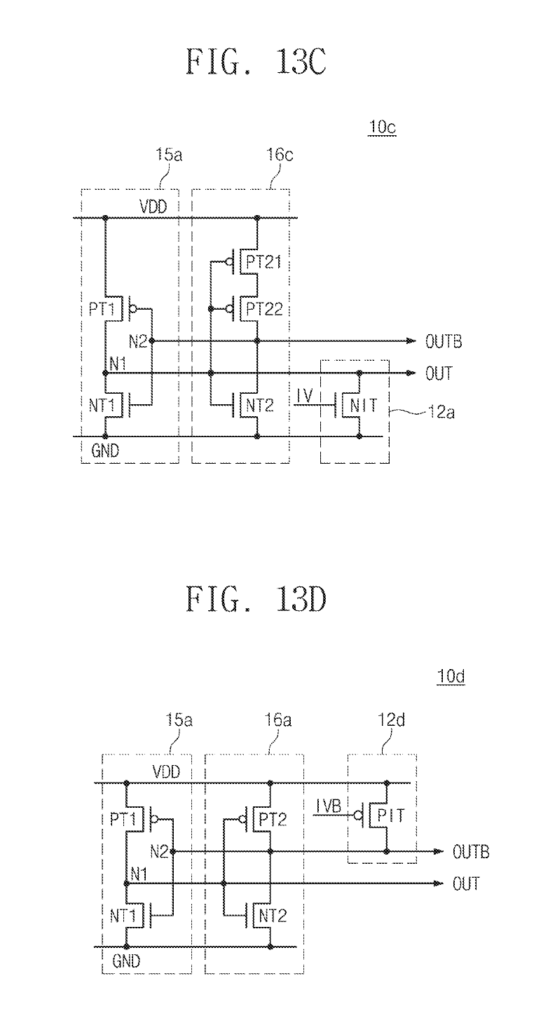

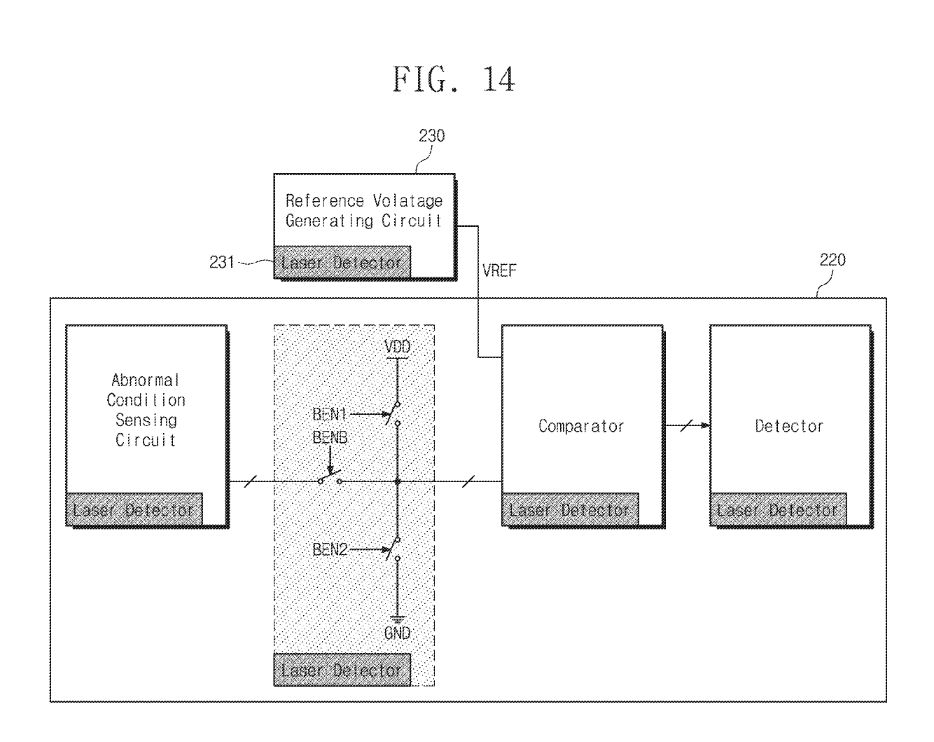

FIGS. 13A, 13B, 13C, and 13D are diagrams illustrating a laser detector in more detail according to exemplary embodiments of the inventive concept.

FIG. 13A is a circuit diagram of a laser detector according to an exemplary embodiment of the inventive concept. Referring to FIG. 13A, a laser detector 10a may include an initial value setting circuit 12a and first and second inverters 15a and 16a. The first inverter 15a may include a first PMOS transistor PT1 and a first NMOS transistor NT1. The first PMOS transistor PT1 is connected between the power supply voltage VDD and the first node N1 and has a gate connected to the second node N2. The first NMOS transistor NT1 is connected between the first node N1 and the ground voltage GND and has a gate connected to the second node N2.

The second inverter 16a may include a second PMOS transistor PT2 and a second NMOS transistor NT2. The second PMOS transistor PT2 is connected between the power supply voltage VDD and the second node N2 and has a gate connected to the first node N1. The second NMOS transistor NT2 is connected between the second node N2 and the ground voltage GND and has a gate connected to the first node N1. According to an exemplary embodiment of the inventive concept, the first node N1 may be a node outputting the output signal OUT, and the second node N2 may be a node outputting the inverted output signal OUTB.

The initial value setting circuit 12a may include an NMOS transistor NIT that is connected between the first node N1 and the ground voltage GND and has a gate connected to receive the initial value signal IV. The NMOS transistor NIT may be turned on in response to the initial value signal IV to initialize the output signal OUT with a low level (e.g., GND).

Some of the first and second PMOS transistors PT1 and PT2 and the first and second NMOS transistors NT1 and NT2 may be designed (e.g., with a layout) to increase reactivity to a laser, and others thereof may be designed (e.g., with a layout) to suppress reactivity to the laser. For example, to increase responsiveness to a laser, some of the first and second PMOS transistors PT1 and PT2 and the first and second NMOS transistors NT1 and NT2 may be designed (e.g., with a layout) to be larger in size than the others.

According to an exemplary embodiment of the inventive concept, the first NMOS transistor NT1 and the second PMOS transistor PT2 may be controlled to be turned on initially by the initial value setting circuit 12a, and the first PMOS transistor PT1 and the second NMOS transistor NT2 may be controlled to be turned off initially by the initial value setting circuit 12a.

The first NMOS transistor NT1 and the second PMOS transistor PT2 that are controlled to be turned on initially may have a relatively small size compared with the first PMOS transistor PT1 and the second NMOS transistor NT2 so as not to react to the laser. In contrast, the first PMOS transistor PT1 and the second NMOS transistor NT2 that are controlled to be turned off initially may have a relatively large size compared with the first NMOS transistor NT1 and the second PMOS transistor PT2 so as to react to the laser well.

A ratio of width to length (W/L) of an active area of each transistor may be adjusted to adjust a size of each of the first NMOS transistor NT1, the second PMOS transistor PT2, the first PMOS transistor PT1, and the second NMOS transistor NT2. A length and/or a width of an active area of each transistor may be adjusted to adjust the W/L.

According to an exemplary embodiment of the inventive concept, a ratio of the W/L of the active area of the first NMOS transistor NT1 to the W/L of the active area of the second NMOS transistor NT2 may be 1:2. Additionally, according to an exemplary embodiment of the inventive concept, a ratio of the W/L of the active area of the second PMOS transistor PT2 to the W/L of the active area of the first PMOS transistor PT1 may be 1:2. However, the inventive concept is not limited thereto.

According to an exemplary embodiment of the inventive concept, to prevent the first NMOS transistor NT1 and the second PMOS transistor PT2 from reacting to the laser, the first NMOS transistor NT1 and the second PMOS transistor PT2 may have a layout to be covered by a metal layer. Additionally, to allow the first PMOS transistor PT1 and the second NMOS transistor NT2 to react to the laser well, the first PMOS transistor PT1 and the second NMOS transistor NT2 may have a layout to not to be covered by a metal layer.

FIG. 13B is a circuit diagram of a laser detector according to an exemplary embodiment of the inventive concept. Referring to FIG. 13B, a laser detector 10b may be implemented to be substantially the same as the laser detector 10a of FIG. 13A except for a second inverter 16b. The second inverter 16b may include the second PMOS transistor PT2 and NMOS transistors NT21 and NT22. Each of the NMOS transistors NT21 and NT22 may be connected between the second node N2 and the ground voltage GND and may have a gate connected to the first node N1.

FIG. 13C is a circuit diagram of a laser detector according to an exemplary embodiment of the inventive concept. Referring to FIG. 13C, a laser detector 10c may be implemented to be substantially the same as the laser detector 10a of FIG. 13A except for a second inverter 16c. The second inverter 16c may include PMOS transistors PT21 and PT22 and the second NMOS transistor NT2. Each of the PMOS transistors PT21 and PT22 may be connected in series between the power supply voltage VDD and the second node N2 and may have a gate connected to the first node N1.

FIG. 13D is a circuit diagram of a laser detector according to an exemplary embodiment of the inventive concept. Referring to FIG. 13D, a laser detector 10d may be implemented to be substantially the same as the laser detector 10a of FIG. 13A except for an initial value setting circuit 12d. The initial value setting circuit 12d may include a PMOS transistor PIT. The PMOS transistor PIT may be connected between the power supply voltage VDD and the second node N2 and may have a gate connected to receive an inverted initial value signal IVB.

It should be understood that the laser detectors 10a to 10d illustrated in FIGS. 13A to 13D are only exemplary embodiments not limiting the spirit and scope of the inventive concept.

According to an exemplary embodiment of the inventive concept, an integrated circuit may be implemented to include a laser detector in a reference voltage generating circuit generating the reference voltage VREF.

FIG. 14 is a diagram illustrating an attack detection circuit including a reference voltage generating circuit according to an exemplary embodiment of the inventive concept. Referring to FIG. 14, an integrated circuit may further include a reference voltage generating circuit 230 connected to the attack detection circuit 220, compared with the attack detection circuit 220 in FIG. 11. The reference voltage generating circuit 230 may include at least one laser detector 231.

The reference voltage generating circuit 230 may generate the reference voltage VREF for an attack detection circuit (e.g., the attack detection circuit 220 of FIG. 11). An attacker may attempt to make an operation of the attack detection circuit 220 weak and ineffective by changing the reference voltage VREF through a laser fault attack. The reference voltage generating circuit 230 according to an exemplary embodiment of the inventive concept may sense an attempt to change the reference voltage VREF by using the laser detector 231, and may reset or shut down the internal circuit 210 (refer to FIG. 10) based on the sensed result.

According to an exemplary embodiment of the inventive concept, an attack detection circuit may perform a laser detecting operation at substantially the same time as a security BIST operation.

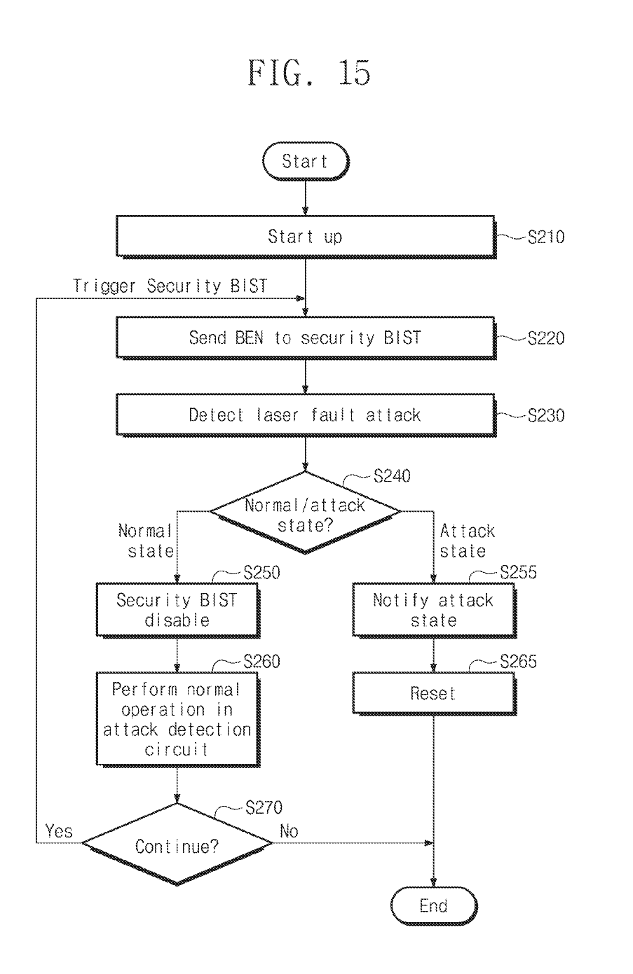

FIG. 15 is a flowchart illustrating a process in which the integrated circuit of FIG. 10 performs a hacking preventing operation according to an exemplary embodiment of the inventive concept. Referring to FIGS. 10 to 15, the hacking preventing operation of the integrated circuit 200 may include operations S210, S220, and S250 to S270. Since the operations S210, S220, and S250 to S270 are similar to the operations S110, S120, and S150 to S170 in FIG. 6, a detailed description thereof is omitted.

According to an exemplary embodiment of the inventive concept, the integrated circuit 200 may detect a laser fault attack in a security BIST mode (S230). For example, as described with reference to FIGS. 10 to 14, each internal component of the attack detection circuit 220 may include a laser detector. The laser detector may be implemented to detect a laser fault attack from an attacker.

The integrated circuit 200 may determine a normal state or an attack state based on a result of detection for the laser fault attack (S240). For example, if the laser fault attack is not detected, it is determined as the normal state, and if the laser fault attack is detected, it is determined as the attack state. The integrated circuit 200 may perform operations S250 to S270 based on the determination.

According to an exemplary embodiment of the inventive concept, the security BIST mode for detecting the laser fault attack has been described with reference to FIG. 15, but the inventive concept is not limited thereto. According to an exemplary embodiment of the inventive concept, the attack detection circuit 220 of the integrated circuit 200 may be configured to detect the laser fault attack in the normal mode, and output or notify an attack notification signal when the laser fault attack is detected.

According to an exemplary embodiment of the inventive concept, the security BIST mode for detecting a laser fault attack in FIG. 15 and the security BIST mode in FIG. 6 may combined with each other to be performed in parallel. For example, an operation for detecting a laser fault attack or an operation for determining a laser fault attack (e.g., operations in FIG. 15) may be performed simultaneously or in parallel with an operation of the security BIST mode in FIG. 6. Alternatively, an operation for detecting a laser fault attack may be performed during the security BIST mode in FIG. 6. In other words, the attack detection circuit 220 may be implemented to perform the security BIST mode and detect a laser fault attack from an attacker through the laser detector.

According to an exemplary embodiment of the inventive concept, an integrated circuit may further include a laser detector in an internal circuit.

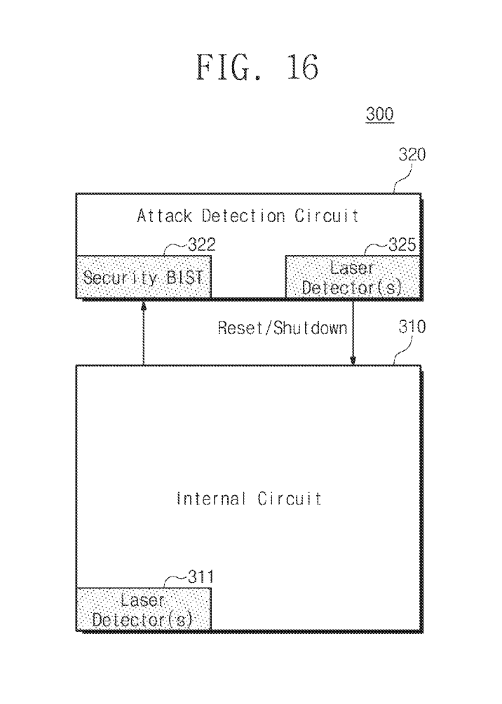

FIG. 16 is a diagram illustrating an integrated circuit according to an exemplary embodiment of the inventive concept. Referring to FIG. 16, an integrated circuit 300 may be implemented to be substantially the same as the integrated circuit 200 of FIG. 10, except for an internal circuit 310 having at least one laser detector 311. An attack detection circuit 320 including a security BIST circuit 322 and at least one laser detector 325 may be substantially the same as the attack detection circuit 220 of FIG. 10 including the security BIST circuit 222 and the at least one laser detector 225.

The attack detection circuit according to exemplary embodiments of the inventive concept may be applied to a memory system (e.g., a smart card).

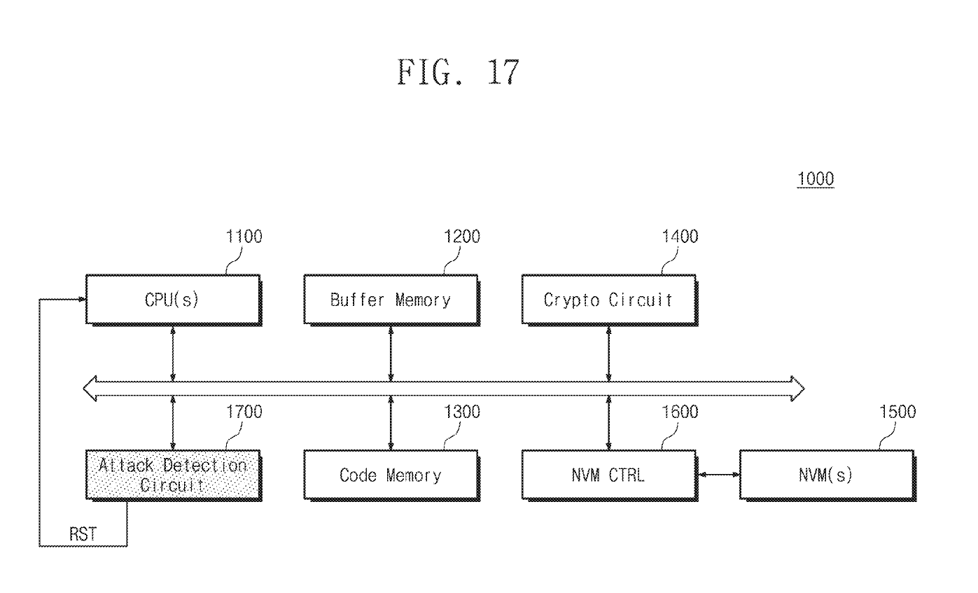

FIG. 17 is a diagram illustrating a security system according to an exemplary embodiment of the inventive concept. Referring to FIG. 17, a security system 1000 may include at least one central processing unit (CPU) 1100, a buffer memory 1200, a code memory 1300, a crypto circuit 1400, a nonvolatile memory device (NVM(s)) 1500, a nonvolatile memory controller (NVM CTRL) 1600, and an attack detection circuit 1700.

The CPU 1100 may be implemented to control overall operations of the security system 1000. The buffer memory 1200 may be implemented to temporarily store data needed to drive the security system 1000. For example, the buffer memory 1200 may be implemented with a random access memory. The code memory 1300 may be implemented to store code data needed to drive the security system 1000. The crypto circuit 1400 may decode (or decrypt) encrypted instructions, perform authentication, process electronic signatures and other data, etc. under control of the CPU 1100. The nonvolatile memory 1500 may be implemented to store data needed to drive the crypto circuit 1400. The nonvolatile memory controller 1600 may be implemented to access the nonvolatile memory 1500 under control of the CPU 1100 or the crypto circuit 1400.

The attack detection circuit 1700 may be implemented with the attack detection circuit described above with reference to FIGS. 1 to 16. When an external attack on internal configurations of the security system 1000 is detected, the attack detection circuit 1700 may generate an attack notification signal RST and may send the attack notification signal RST to the CPU 1100.

The security system 1000 may be implemented to further include a laser detector in a crypto circuit to enhance security of the crypto circuit.

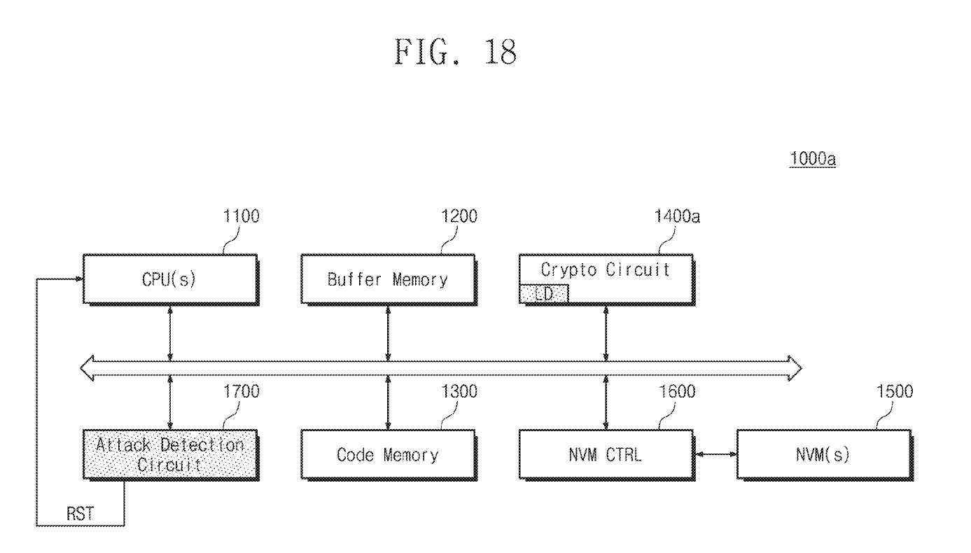

FIG. 18 is a diagram illustrating a security system according to an exemplary embodiment of the inventive concept. Referring to FIG. 18, a security system 1000a may be implemented to be substantially the same as the security system 1000 of FIG. 17, except for a crypto circuit 1400a. The crypto circuit 1400a may include a laser detector LD for detecting a laser fault attack.

An attack detection circuit according to an exemplary embodiment of the inventive concept may be applied to a security identification card.

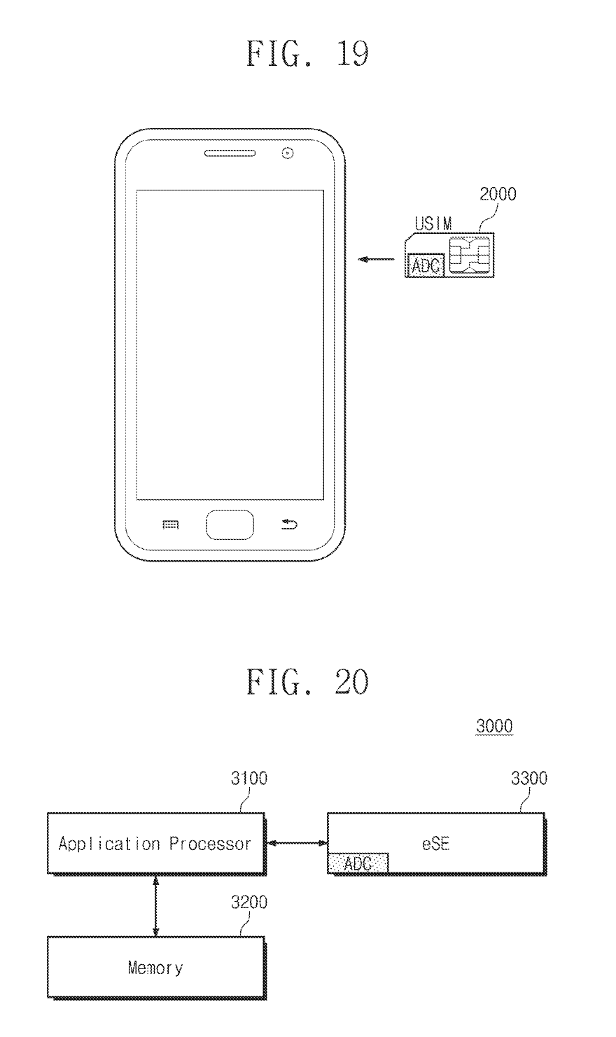

FIG. 19 is a diagram illustrating a security chip configured to be inserted into a mobile device according to an exemplary embodiment of the inventive concept. Referring to FIG. 19, a security chip 2000 may include an attack detection circuit ADC, corresponding to the attack detection circuit described above with reference to FIGS. 1 to 16. According to an exemplary embodiment of the inventive concept, the security chip 2000 may be a subscriber identification module (SIM) card, a universal SIM (USIM) card, a smart card, etc.

An attack detection circuit according to an exemplary embodiment of the inventive concept may be applied to a security product embedded in a mobile device.

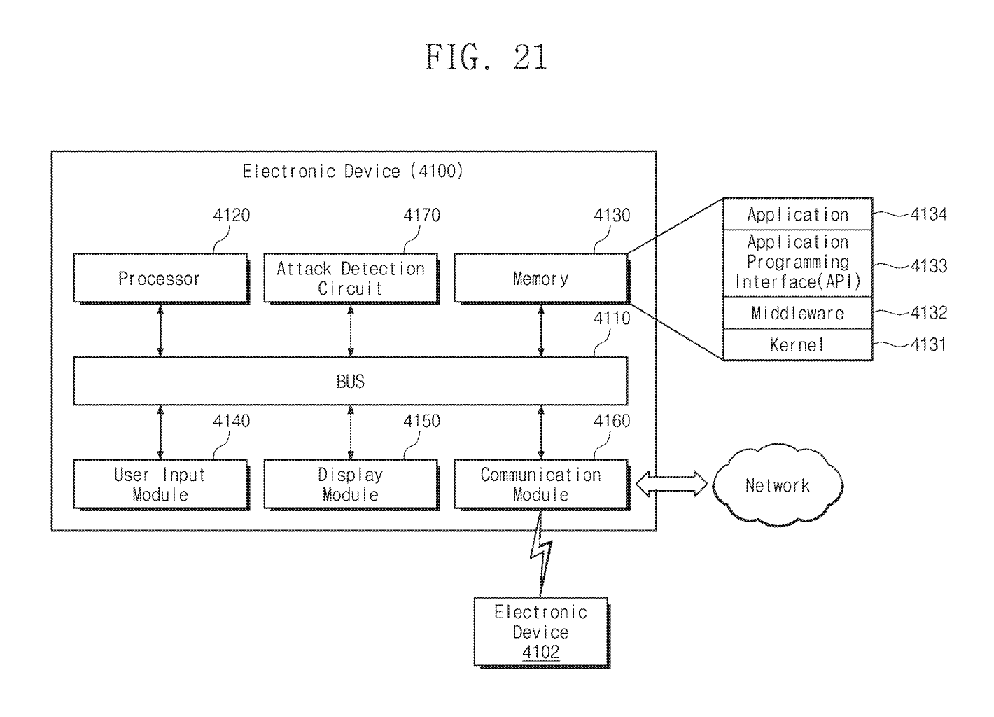

FIG. 20 is a diagram illustrating a mobile device according to an exemplary embodiment of the inventive concept. Referring to FIG. 20, a mobile device 3000 may include an application processor (AP) 3100, a memory 3200, and a security chip (eSE) 3300.

The application processor 3100 may be implemented to control overall operations of the mobile device 3000 and wired/wireless communication with the outside. The memory 3200 may be implemented to temporarily store data needed for a processing operation of the mobile device 3000. According to an exemplary embodiment of the inventive concept, the memory 3200 may be implemented with a dynamic random access memory (DRAM), a synchronous DRAM (SDRAM), a magnetic RAM (MRAM), etc. The security chip 3300 may be implemented with software and/or tamper resistant hardware, may control high-level security, and may work in cooperation with a trusted execution environment (TEE) of the application processor 3100. For example, the security chip 3300 may perform an encryption and decryption operation, message authentication code (MAC) generation/verification, etc. performed in the TEE.

The security chip 3300 may include a native operating system as an operating system, a secure storage device that is an internal data storage, an access control block that controls authority to access the security chip 3300, a security function block that performs ownership management, key management, digital signature processing, encryption/decryption, etc., and a firmware update block that updates firmware of the security chip 3300. The security chip 3300 may be, for example, an embedded secure element (eSE). Additionally, the security chip 3300 may be implemented to include an attack detection circuit as described above with reference to FIGS. 1 to 16.

The mobile device 3000 may further include a display/touch module. The display/touch module may be implemented to display data processed by the application processor 3100 or to receive data from a touch panel.

The mobile device 3000 may further include a storage device. The storage device may be implemented to store data of a user. The storage device may be an embedded multimedia card (eMMC), a solid state drive (SSD), a universal flash storage (UFS), etc. The storage device may include at least one nonvolatile memory device. The nonvolatile memory device may be a NAND flash memory, a vertical NAND flash memory (VNAND), a NOR flash memory, a resistive random access memory (RRAM), a phase change memory (PRAM), a magneto-resistive random access memory (MRAM), a ferroelectric random access memory (FRAM), a spin transfer torque random access memory (STT-RAM), etc.

Furthermore, the nonvolatile memory device may be implemented to have a three-dimensional (3D) array structure. In an exemplary embodiment of the inventive concept, a 3D memory array is provided. The 3D memory array is monolithically formed with one or more physical levels of arrays of memory cells having an active area disposed above a silicon substrate and circuitry associated with the operation of those memory cells, whether such associated circuitry is above or within the silicon substrate. The term “monolithic” indicates that layers of each level of the memory array are directly deposited on the layers of an underlying level of the memory array.

In an exemplary embodiment of the inventive concept, the 3D memory array includes vertical NAND strings that are vertically oriented such that at least one memory cell is disposed over another memory cell. The at least one memory cell may comprise a charge trap layer. Each vertical NAND string may include at least one selection transistor located over the memory cells. At least one selection transistor may have substantially the same structure as those of the memory cells and may be monolithically formed together with the memory cells.

The 3D memory array is formed of a plurality of levels and has word lines or bit lines shared among the levels. The following patent documents, which are hereby incorporated by reference, describe suitable configurations for 3D memory arrays: U.S. Pat. Nos. 7,679,133, 8,553,466, 8,654,587, and 8,559,235; and U.S. Pat. Pub. No. 2011/0233648. The nonvolatile memory according to exemplary embodiments of the inventive concept may be applicable to a charge trap flash (CTF) in which an insulating layer is used as a charge storage layer, as well as a flash memory device in which a conductive floating gate is used as a charge storage layer.

An attack detection circuit according to an exemplary embodiment of the inventive concept may be applied to an electronic device.

FIG. 21 is a diagram illustrating an electronic device according to an exemplary embodiment of the inventive concept. The electronic device according to an exemplary embodiment of the inventive concept may be a device that includes a communication function. For example, an electronic device 4100 may be one of the following devices or a combination of two or more thereof: a data storage medium (e.g., a solid state drive (SSD), a memory stick, a universal flash storage (UFS) device), a memory card (e.g., a secure digital (SD), a multimedia card (MMC), an embedded MMC (eMMC), or the like), a smart card, a mobile device, a smartphone, a tablet personal computer (PC), a mobile phone, a video phone, an e-book reader, a desktop PC, a laptop PC, a netbook computer, a personal digital assistant (PDA), a portable multimedia player (PMP), an MP3 player, a mobile medical device, an electronic bracelet, an electronic necklace, an electronic accessory, a camera, a wearable device, an electronic clock, a wrist watch, a smart appliance (e.g., a refrigerator, an air conditioner, a vacuum cleaner, an artificial intelligence robot, a television (TV), a digital video disk (DVD) player, an audio system, an oven, a microwave oven, a washing machine, an air cleaner, or the like), various kinds of medical devices (e.g., a magnetic resonance angiography (MRA) device, a magnetic resonance imaging (MRI) device, a computed tomography (CT) device, a camera, an ultrasonic machine, or the like), a navigation device, a global positioning system (GPS) receiver, an event data recorder (EDR), a flight data recorder (FDR), a set-top box, a TV box, an electronic dictionary, a car infotainment device, an electronic equipment for ships (e.g., a navigation system for ship, a gyrocompass, or the like), an avionics system, a security device, electronic clothes, an electronic key, a camcorder, a game console, a head-mounted display (HMD), a flat panel display device, an electronic picture frame, an electronic album, furniture or a part of a building or a structure that includes a communication function, an electronic board, an electronic signature receiving device, a projector, etc. It is to be understood that the electronic device 4100 is not limited to the above-described devices.

The electronic device 4100 may include a bus 4110, a processor 4120, a memory 4130, a user input module 4140, a display module 4150, a communication module 4160, and an attack detection circuit 4170.

The bus 4110 may be a circuit that interconnects the above-described components and conveys communications (e.g., a control message) between the above-described components.

The processor 4120 may receive, for example, a command from the above-described other components (e.g., the memory 4130, the user input module 4140, the display module 4150, and the communication module 4160) through the bus 4110, may decode the received command, and may perform an arithmetic operation or a data processing operation based on the decoded command.

The memory 4130 may store instructions or data which are received from the processor 4120 or other components (e.g., the user input module 4140, the display module 4150, and the communication module 4160) or are generated by the processor 4120 or the other components. The memory 4130 may include programming modules, for example, a kernel 4131, a middleware 4132, an application programming interface (API) 4133, and an application 4134. Each of the above-mentioned programming modules may be configured with software, firmware, hardware, or a combination of at least two or more thereof.

The kernel 4131 may control or manage system resources (e.g., the bus 4110, the processor 4120, and the memory 4130) that are used to execute operations or functions of other programming modules (e.g., the middleware 4132, the API 4133, and the application 4134). Additionally, the kernel 4131 may provide an interface that allows the middleware 4132, the API 4133, or the application 4134 to access discrete components of the electronic device 4100 so as to control or manage system resources.

The middleware 4132 may perform, for example, a mediation role such that the API 4133 or the application 4134 communicates with the kernel 4131 to exchange data. Additionally, with regard to task requests received from the application 4134, the middleware 4132 may perform load balancing on a task request by using a method of assigning the priority, which makes it possible to use a system resource (e.g., the bus 4110, the processor 4120, or the memory 4130) of the electronic device 4100, to at least one of a plurality of applications of the application 4134.

The API 4133, which is an interface through which the application 4134 controls a function provided by the kernel 4131 or the middleware 4132, may include, for example, at least one interface or function for a file control, a window control, image processing, a character control, etc.

The user input module 4140 may convey an instruction or data received from a user to the processor 4120 or the memory 4130 through the bus 4110. The display module 4150 may display a video, an image, or data to the user.

The communication module 4160 may establish communication between any other electronic device 4102 and the electronic device 4100. The communication module 4160 may support short range communication protocols (e.g., wireless fidelity (Wi-Fi), Bluetooth (BT), and near field communication (NFC)) or network communications (e.g., Internet, a local area network (LAN), a wide area network (WAN), a telecommunications network, a cellular network, a satellite network, and plain old telephone service (POTS)). The electronic device 4102 may be a device that is substantially the same (e.g., the same type) as or different (e.g., a different type) from the electronic device 4100.

The attack detection circuit 4170 may be implemented to detect an external attack thereon or on internal configurations of the electronic device 4100 and to prevent information leakage from the detected attack. According to an exemplary embodiment of the inventive concept, the attack detection circuit 4170 may be implemented with the attack detection circuit described above with reference to FIGS. 1 to 16.

The electronic device 4100 may include a biometric information management module to provide an additional security function. The biometric information management module may manage creation, storage, and deletion of biometric information of a user.

A security system according to an exemplary embodiment of the inventive concept may automatically determine whether a security detector operates abnormally, by using a security BIST. In the case of an abnormal operation, an attack state of the security detector may be conveyed to the interior of the system, and the security system may perform a system reset operation or may delete significant information. Additionally, the security system may add a laser detector, which operates in a normal mode and a security BIST mode, in the vicinity of an attack sensing block.

The security system may block in advance a physical attack or a laser fault attack on security detectors to prevent hacking against a chip, thus increasing the security reliability of the security system. Therefore, security products to which the security system is applied have a high security level.

According to an exemplary embodiment of the inventive concept, an integrated circuit, a mobile device including the same, and an operating method thereof may block a hacking attack on an internal circuit of the integrated circuit in real time by monitoring a physical attack or a laser fault attack on an attack detection circuit of the integrated circuit.

While the inventive concept has been described with reference to exemplary embodiments thereof, it will be apparent to those of ordinary skill in the art that various changes and modifications may be made thereto without departing from the spirit and scope of the inventive concept as set forth in the following claims.

1. An integrated circuit comprising:
an internal circuit; and
an attack detection circuit including at least one sensor configured to sense at least one abnormal condition of the internal circuit,
wherein the at least one abnormal condition is a parameter of the internal circuit that is outside of a predetermined range,
the attack detection circuit is configured to sense an external attack on the internal circuit based on the at least one abnormal condition, and
the attack detection circuit further includes a security built-in-self-test (BIST) circuit configured to sense a physical attack on the attack detection circuit.

2. The integrated circuit of claim 1, wherein the internal circuit is implemented to perform a security function.

3. The integrated circuit of claim 1, wherein the at least one sensor includes at least one of an abnormal frequency sensor, an abnormal voltage sensor, an abnormal temperature sensor, a light exposure sensor, a glitch attack sensor, or a decapsulation sensor.

4. The integrated circuit of claim 3, wherein the attack detection circuit further includes:
a comparator configured to compare an output value of the security BIST circuit with a reference voltage, and
wherein the security BIST circuit includes:
a floating switch configured to connect an output terminal of the at least one sensor and an output terminal of the security BIST circuit in response to an inverted BIST enable signal; and
a pull-up switch configured to connect a power terminal supplied with a power supply voltage and the output terminal of the security BIST circuit in response to a BIST enable signal.

5. The integrated circuit of claim 3, wherein the attack detection circuit further includes:
a comparator configured to compare an output value of the security BIST circuit with a reference voltage, and
wherein the security BIST circuit includes:
a floating switch configured to connect an output terminal of the at least one sensor and an output terminal of the security BIST circuit in response to an inverted BIST enable signal; and
a pull-down switch configured to connect the output terminal of the security BIST circuit and a ground terminal supplied with a ground voltage in response to a BIST enable signal.

6. The integrated circuit of claim 3, wherein the attack detection circuit further includes:
a comparator configured to compare an output value of the security BIST circuit with a reference voltage, and
wherein the security BIST circuit includes:
a floating switch configured to connect an output terminal of the at least one sensor and an output terminal of the security BIST circuit in response to an inverted BIST enable signal;
a pull-up switch configured to connect a power terminal supplied with a power supply voltage and the output terminal of the security BIST circuit in response to a first BIST enable signal; and
a pull-down switch configured to connect the output terminal of the security BIST circuit and a ground terminal supplied with a ground voltage in response to a second BIST enable signal.

7. The integrated circuit of claim 1, wherein the security BIST circuit is activated in response to a BIST enable signal, and
wherein the attack detection circuit operates in one of a security BIST mode in which the security BIST circuit is activated and a normal mode in which the security BIST circuit is deactivated.

8. The integrated circuit of claim 7, wherein the BIST enable signal is generated from the internal circuit periodically or randomly.

9. The integrated circuit of claim 7, wherein when an output value of the security BIST circuit in the normal mode is different from an output value of the security BIST circuit in the security BIST mode, the attack detection circuit determines itself to be in a normal state, and
when the output value of the security BIST circuit in the normal mode is the same as the output value of the security BIST circuit in the security BIST mode, the attack detection circuit determines itself to be in an attack state.

10. The integrated circuit of claim 9, wherein when the attack state of the attack detection circuit is determined, the internal circuit is reset or shut down, or data being processed in the internal circuit is deleted.

11. The integrated circuit of claim 1, wherein the attack detection circuit further includes:
at least one laser detector configured to sense a laser fault attack.

12. The integrated circuit of claim 11, wherein the at least one laser detector includes:
an initial value setting circuit for setting an initial value of the at least one laser detector; and
a latch circuit configured to latch the initial value.

13. An integrated circuit comprising:
an internal circuit; and
an attack detection circuit configured to sense an external attack on the internal circuit,
wherein the attack detection circuit includes:
a plurality of sensors configured to sense different abnormal conditions;
a plurality of built-in-self-test (BIST) units corresponding to the plurality of sensors, wherein each of the plurality of BIST units is configured to output one of a voltage from a corresponding sensor, a ground voltage, and a power supply voltage as an output value;
a comparator configured to compare each of the output values of the plurality of BIST units with a reference voltage and output at least one result value; and
a detector configured to generate an attack notification signal in response to the at least one result value of the comparator.

14. The integrated circuit of claim 13, wherein each of the plurality of BIST units includes:
a floating switch configured to be connected to an output terminal of a corresponding one of the plurality of sensors in response to an inverted BIST enable signal; and
one of a pull-up switch configured to be connected to a power terminal in response to a BIST enable signal or a pull-down switch configured to be connected to a ground terminal in response to the BIST enable signal.

15. The integrated circuit of claim 13, wherein the comparator includes:
a plurality of comparison units corresponding to the plurality of BIST units, and
wherein each of the plurality of comparison units compares the output value of a corresponding BIST unit with the reference voltage.

16. The integrated circuit of claim 13, wherein at least one of the plurality of sensors, the plurality of BIST units, the comparator, and the detector includes:
a first laser detector configured to sense a laser fault attack.

17. The integrated circuit of claim 16, further comprising:
a reference voltage generator configured to generate the reference voltage,
wherein the reference voltage generator includes a second laser detector configured to sense a laser fault attack.

18. The integrated circuit of claim 13, wherein the internal circuit includes at least one laser detector.

19. The integrated circuit of claim 13, wherein the internal circuit includes:
a central processing unit;
a buffer memory configured to store data from the central processing unit;
a code memory configured to store a program to drive the central processing unit; and
a crypto circuit configured to perform an encryption/decryption operation on the data,
wherein the crypto circuit includes at least one laser detector.

20. A mobile device comprising:
an application processor;
a memory configured to store data used for an operation of the application processor; and
a security chip configured to perform a security operation of the application processor,
wherein the security chip includes:
an attack detection circuit including a security built-in-self-test (BIST) circuit configured to sense a physical attack or a laser fault attack on the attack detection circuit.

21-25. (canceled)
